(19) United States
(12) Patent Application Publication
(10) Pub. No.: US 2019/0166413 A1
(43) Pub. Date: May 30, 2019

(54) Monitor for Underground Infrastructure

(71) Applicant: CNIguard Ltd, Stanmore (GB)

(72) Inventors: Edward Klinger, Stanmore (GB); Stephen Jeffreys, Droitwich Spa (GB); Ian Courtney, Walton-on-Thames (GB); Peter Massam, Saffron Walden (GB); Glenn Wilkinson, Cambridge (GB)

(21) Appl. No.: 16/205,787

(22) Filed: Nov. 30, 2018

Related U.S. Application Data
(60) Provisional application No. 62/592,449, filed on Nov. 30, 2017.

(30) Foreign Application Priority Data
Nov. 30, 2017 (GB) 1719971.2

(51) Int. Cl. H04Q 9/00; H04L 29/08

(52) U.S. Cl. CPC H04Q 9/00; H04Q 2209/823; H04L 67/12

(57) ABSTRACT

A device for monitoring an underground utility vault environment includes environmental sensors including at least one primary sensor and at least one secondary sensor, a processor for receiving output data from the sensors and for compiling an alarm data packet, and a communications module for transmitting data from the device. The processor determines whether an alarm condition is present based on the output data from the primary sensor(s) and, when an alarm condition is present, compiles an alarm data packet comprising data derived from the primary sensor(s) and secondary sensor(s), and causes the communications module to transmit the alarm data packet. The primary sensor(s) may include a carbon monoxide sensor. The device may include a waterproof housing, a plurality of internal sensors including a gas sensor, and a port for allowing gas exchange between the environment outside the housing and the gas sensor and preventing water ingress.

### CROSS-REFERENCE TO RELATED APPLICATIONS

This application claims the benefit of U.S. Provisional Patent Application No. 62/592,449 filed Nov. 30, 2017, and claims priority to United Kingdom Patent Application No. 1719971.2 filed Nov. 30, 2017, the disclosures of which are hereby incorporated by reference in their entirety.

### FIELD OF THE INVENTION

The present invention relates to a monitor for underground infrastructure. In particular, but not exclusively, the invention relates to a device for monitoring the environment in a utility vault.

### BACKGROUND TO THE INVENTION

Utility vaults, also known as manholes, utility boxes, cable chambers, inspection chambers, access chambers and so on, are underground chambers that house utility infrastructure such as electrical supply cables and equipment, switchgear, telecommunications equipment, and supply pipes for natural gas, water and steam.

Utility vaults can usually be accessed from street level by way of an access opening that is closed by a removable cover or hatch. The cover or hatch is usually installed flush with the roadway or pavement (sidewalk) and is of sufficient strength to withstand vehicle and pedestrian traffic. Most utility vaults are fabricated as pre-cast concrete units or are constructed on site from concrete or brick. However, utility vaults made from plastics materials are also available.

The size, shape and use of utility vaults can vary considerably, from small units with a volume of less than 1 cubic metre, for housing a relatively small number of connectors, switches or valves, up to very large units with volumes of 60 cubic metres or more, capable of housing large electrical equipment such as transformers.

Various faults and problems can occur in utility vaults which, in certain circumstances, can present a risk to public safety. For example, aged, faulty or damaged electrical supply cables can cause electrical short-circuits that may eventually result in fire or explosion. Harmful gaseous products of burning or smouldering cables can include carbon monoxide, carbon dioxide, acetylene, methane, and polycyclic aromatic hydrocarbons, creating a toxic environment within the vault. An increase in pressure in the vault can eventually cause the cover or hatch to be violently propelled into the air. To combat this problem, covers are increasingly provided with vents to allow gases and smoke to escape, avoiding a build-up in pressure.

Another potential problem is that stray voltages within the vault due to cable or equipment faults can result in a substantial electrical potential being presented at street level if the cover or hatch is metal, posing a risk of electrocution.

These and other problems can be exacerbated by the challenging environment within the vault. The temperature within vaults can vary significantly, from around −20° C. or less in winter conditions up to around 105° C. or more in vaults carrying steam pipes. Also, flooding of the vault and the wash-off of road salt into the vault environment are relatively common occurrences. Such flooding is more likely where vented covers are used, although it is still a problem with solid covers and hatches, which are often imperfectly sealed. The combination of salt and moisture substantially increases the risk of short circuits and arcing within the vault.

For these reasons, frequent manual inspection of utility vaults is desirable, so that any developing problems can be identified and rectified to minimise the safety risk. However, the frequency of manual inspections is limited by practical considerations due to the very large number of utility vaults (over 250,000 vaults are in service in New York City alone), the geographic spread of the vaults, and the relative inaccessibility of some vaults. As a result, the time between manual inspections may be long enough for faults to arise and develop into a serious condition before they can be identified.

Against that background, it would be desirable to provide apparatus for remotely and automatically monitoring the environment within a utility vault and for alerting engineers to developing problems within the utility vault.

### SUMMARY OF THE INVENTION

From a first aspect, the present invention resides in a device for monitoring an underground utility vault environment, including:
a plurality of environmental sensors comprising at least one primary sensor and at least one secondary sensor;
a processor for receiving output data from the sensors and for compiling an alarm data packet; and
a communications module for transmitting data from the device; wherein the processor is configured to:
   determine whether an alarm condition is present based on the output data from the or each primary sensor;
   and, when it is determined that an alarm condition is present, compile an alarm data packet comprising data derived from the or each primary sensor and the or each secondary sensor, and cause the communications module to transmit the alarm data packet;
and wherein the plurality of environmental sensors includes a primary sensor comprising a carbon monoxide sensor.

The present inventors have determined that using a carbon monoxide sensor as a primary sensor provides a particularly effective and reliable early indication of combustion within a utility vault due to electrical arcing or insulation breakdown. Furthermore, by also including secondary sensor data in the alarm data packet, the nature and severity of such a fault can be more readily determined.

The device may include a further primary sensor comprising a temperature sensor. In this way, an alarm data packet can be transmitted when the carbon monoxide level in the vault exceeds a predetermined threshold, when the temperature in the vault exceeds a predetermined threshold, and/or when the temperature rises at a rate that exceeds a predetermined rate.

The device may comprise one or more further primary sensors selected from the group consisting of an electrical arc sensor, a smoke sensor, a stray voltage sensor, a water sensor, and a tamper sensor. In each case, such sensors provide a useful indication of faults that may occur within the vault.

The device may include one or more secondary sensors selected from the group consisting of a humidity sensor, an atmospheric pressure sensor, a methane sensor, a water sensor, an acceleration sensor, a tamper sensor, a light sensor, an electrical current sensor, an electrical voltage sensor and an audio sensor.

Preferably, the device further comprises a camera module. The processor may be configured to cause the camera module to acquire an image of the interior of the utility vault when it is determined that an alarm condition is present, and to transmit the acquired image. The acquired imaged may for example be transmitted in the alarm data packet or in one or more image data packets. The camera module may be configured to acquire an infrared image and/or a visible light image.

Preferably, the or at least one of the secondary sensors is switchable between a sleep state in which the sensor is not operational and an awake state in which the sensor transmits output data to the processor, and the processor is configured to switch the sensor from the sleep state to the awake state when it is determined that an alarm condition is present. In this way, power consumption within the device can be minimised.

For the same reason, the or at least one of the primary sensors may be switchable between a sleep state in which the sensor is not operational and an awake state in which the sensor transmits output data to the processor, and the processor may be configured to switch the sensor from the sleep state to the awake state at predetermined polling time intervals.

The processor is preferably configured to obtain data from at least one sensor at predetermined polling time intervals and to log the obtained data in a memory. The processor may further be configured to compile one or more reporting data packets comprising logged data and to cause the communications module to transmit the one or more reporting data packets at predetermined reporting time intervals. In this way, the device can be arranged to communicate regularly with the receiver even when no alarm condition is present, and the data obtained by the receiver can be used to check for correct operation of the device as well as for the identification of further faults within the vault. The processor may also be configured to cause the communications module to transmit one or more reporting data packets upon receiving a request, for example from the receiver.

The communications module is preferably configured to receive firmware update data from a remote server or other device. For example, threshold values for alarm conditions can be updated. In another example, communication with the remote server or other device could be used to set the monitoring device into a specific mode suitable for use in particular conditions, such as when inclement weather is predicted, for testing purposes, and so on. Such modes could include values for threshold values, polling intervals, reporting intervals, and so on.

In a second aspect, the invention resides in a device for monitoring an underground utility vault environment, comprising:
a waterproof housing having an interior and defining an exterior of the device;
a plurality of internal sensors including a gas sensor for measuring a gas concentration in the utility vault environment;
a communications module for transmitting sensor-related data from the device; and
a power supply for supplying electrical power to the device;
wherein the plurality of internal sensors, the communications module and the power supply are mounted in the interior of the housing;
the device further comprising a port for allowing gas exchange between the environment outside the housing and the gas sensor, the port being arranged to prevent water ingress from the exterior into the interior of the housing.

In this way, a self-contained device is provided that is able to monitor the conditions within the challenging environment of a utility vault with a low risk of device failure in the event that the vault becomes flooded. In particular, by virtue of the port, the device is able to monitor atmospheric conditions in the vault using the or each gas sensor whilst still being resistant to flood damage if the device becomes immersed in water. In one embodiment, the port comprises a micropermeable membrane that allows gas flow through the port and prevents water ingress through the port. A grille arranged to protect the port may be provided.

Preferably, the device comprises at least one water sensor. The water sensor may comprise a pair of electrical contacts mounted on the exterior of the housing such that, in use, water bridging the pair of contacts is detectable by an increase in electrical conductivity between the contacts.

Preferably, the electrical contacts are disposed adjacent to the port. For example, the contacts may be annular and arranged concentrically around the port such that, in use, water bridges the pair of contacts before reaching the port irrespective of the orientation of the device.

The port may comprise an aperture in the housing and a valve member moveable between an open position in which the aperture is open to allow gas flow into the interior of the housing and a closed position in which the valve member seals the aperture to prevent water ingress, and wherein the device is arranged to move the valve member to the closed position upon detection of water by the water sensor. When the water sensor includes annular electrical contacts arranged around the port, the valve can be closed before the water reaches the port irrespective of the orientation of the device. This means that the device can be positioned in any orientation, easing installation of the device in the vault.

Preferably, the gas sensor comprises a carbon monoxide sensor. The internal sensors may comprise one or more further gas sensors selected from the group consisting of a methane sensor, a humidity sensor and a smoke sensor.

The internal sensors may comprise one or more sensors selected from the group consisting of a temperature sensor, an electrical arc sensor, a stray voltage sensor, a water sensor, and a tamper sensor.

Alternatively or additionally, the internal sensors may comprise one or more sensors selected from the group consisting of an atmospheric pressure sensor, an acceleration sensor, a light sensor, and an audio sensor.

Preferably, the device further comprises a camera module for acquiring images of the interior of the utility vault. The camera module may be external to the housing.

The communications module and at least one internal sensor are mounted on a main circuit board and the gas sensor is mounted on a daughter circuit board. The main circuit board may be encapsulated and daughter circuit board may be at least partially unencapsulated. In this way, the components on the main board can be well protected against corrosion and moisture without interfering with the functioning of the gas sensor.

From a third aspect, the present invention provides a device for monitoring an underground utility vault environment, comprising a waterproof housing defining an interior and an exterior, a sensing chamber defined at least in part by the exterior of the housing and having a cover configured to allow fluid communication between the sensing chamber and the utility vault environment, a plurality of sensors including a gas sensor for measuring a gas concentration in the utility vault environment and a water sensor for detecting the presence of water in the sensing chamber, and a communications module for transmitting sensor-related data from the device. The gas sensor and the communications module are mounted in the interior of the housing. The device further comprises a port for allowing gas exchange between the sensing chamber and the gas sensor, the port being arranged to prevent water ingress from the exterior into the interior of the housing.

With this arrangement, a self-contained device is provided that is able to monitor the conditions within the challenging environment of a utility vault with a low risk of device failure in the event that the vault becomes flooded. In particular, by virtue of the port, the device is able to monitor atmospheric conditions in the vault using the or each gas sensor whilst still being resistant to flood damage if the device becomes immersed in water. The sensing chamber provides physical protection for the port. Furthermore, because the gas sensor and the water sensor are each configured to detect gas and water, respectively, in the sensing chamber, the information obtained from the water sensor can be useful in interpreting the results from the gas sensor. For instance, data from the water sensor may indicate a flooding event in which the sensing chamber is filled with water, which increases the likelihood of a false zero reading from the gas sensor.

The water sensor may comprise a detector responsive to contact with water, and the detector is preferably disposed in the sensing chamber. The detector may comprise a pair of electrical contacts such that, in use, water bridging the pair of contacts is detectable by an increase in electrical conductivity between the contacts.

Preferably, the electrical contacts are disposed adjacent to the port. In an embodiment, the contacts are annular and arranged concentrically around the port such that, in use, water bridges the pair of contacts before reaching the port irrespective of the orientation of the device.

The port may comprise a micropermeable membrane that allows gas flow through the port and prevents water ingress through the port. The membrane preferably covers an aperture in the housing.

Alternatively, the port may comprise an aperture in the housing and a valve member moveable between an open position in which the aperture is open to allow gas flow into the interior of the housing and a closed position in which the valve member seals the aperture to prevent water ingress. The device may be arranged to move the valve member to the closed position upon detection of water by the water sensor.

The cover may comprise a grille. Preferably, the cover is arranged to guard against intrusion into the sensing chamber. In this way, damage to the port and other components, such as water sensor detectors, can be avoided.

The communications module may be mounted on a main circuit board and the gas sensor may be mounted on a daughter circuit board disposed adjacent to a wall of the sensing chamber.

The device may further comprise a power supply for supplying electrical power to the device. The power supply is preferably disposed in the interior of the housing.

The gas sensor preferably comprises a carbon monoxide sensor, which provides a particularly effective and reliable early indication of combustion within a utility vault due to electrical arcing or insulation breakdown.

The remaining sensors may comprise one or more further gas sensors selected from the group consisting of a further carbon monoxide sensor, a methane sensor, a humidity sensor and a smoke sensor. The remaining sensors may comprise one or more sensors selected from the group consisting of a temperature sensor, an electrical arc sensor, a stray voltage sensor, a water sensor, a current sensor, a voltage sensor and a tamper sensor. The remaining sensors may comprise one or more sensors selected from the group consisting of an atmospheric pressure sensor, an acceleration sensor, a light sensor, and an audio sensor.

The device may include a camera module for acquiring images of the interior of the utility vault. The camera module may be configured to acquire an infrared image and/or a visible light image.

The invention also extends, in a further aspect, to an underground vault monitoring system, comprising a device according to the first, second and/or third aspect of the invention and a receiver, for example a remote server, for communication with the device by way of a network. A plurality of such devices, each in communication with a receiver, for example a remote server, may be provided, so that a plurality of utility vaults can be monitored by a single receiver.

Preferred and/or optional features of each aspect of the invention may be used, alone or in appropriate combination, in the other aspects also.

The features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Embodiments of the present invention will now be described with reference to the accompanying drawings, in which like reference signs are used for like features, and in which:

FIG. 1 shows an underground utility vault fitted with a monitoring device according to the present invention and a receiver in communication with the monitoring device via a network;

FIG. 2 shows a plurality of underground utility vaults fitted with respective monitoring devices according to the present invention, and a receiver in communication with each of the monitoring devices via a network;

FIG. 3 is a cross-sectional view of a monitoring device according to the invention;

FIG. 4 is a block diagram showing hardware components of the monitoring device of FIG. 3;

FIG. 5 is a side view of the monitoring device of FIG. 3, showing a water sensor element assembly;

FIG. 6 is a block diagram showing software components of the monitoring device of FIG. 3;

FIG. 7 is a block diagram showing a wake bus data structure of the monitoring device of FIG. 3;

FIG. 8 is a flowchart showing a sequence of events in a waking process of the monitoring device of FIG. 3;

FIG. 9 is a flowchart showing a sequence of events in an alarm process of the monitoring device of FIG. 3;

FIG. 10 is a cross-sectional view of another monitoring device according to the invention;

FIG. 11 shows an underground utility vault fitted with the monitoring device of FIG. 10; and

FIG. 12 shows a network architecture for data communication between a plurality of monitoring devices and a receiver.

### DESCRIPTION OF THE PREFERRED EMBODIMENTS

Non-limiting embodiments or aspects of the present invention are directed to systems, devices, methods, and computer program products for monitoring an underground utility vault environment. Non-limiting embodiments or aspects of the present invention provide a plurality of environmental sensors including at least one primary sensor and at least one secondary sensor, wherein at least one primary sensor is a carbon monoxide detector. Non-limiting embodiments or aspects of the present invention provide a processor configured to determine whether an alarm condition is present based on the output data from the or each primary sensor and, if so, transmit an alarm data packet comprising data derived from the or each primary sensor and the or each secondary sensor. Accordingly, the environment within a utility vault can be remotely and automatically monitored and engineers can be alerted to developing problems within the utility vault. Additionally, the use of a carbon monoxide sensor can provide a particularly effective and reliable early indication of an alarm condition, whereas also including secondary sensor data in the alarm data packet can enable the nature and severity of the alarm condition to be more readily determined.

Non-limiting embodiments or aspects of the present invention are directed to systems, devices, and methods for monitoring an underground utility vault environment. Non-limiting embodiments or aspects of the present invention provide a waterproof housing and a port for allowing gas exchange between the environment outside the housing and a plurality of internal sensors including a gas sensor within the housing, wherein the port can prevent water ingress from the exterior into the interior of the housing. Accordingly, the environment within a utility vault can be remotely and automatically monitored and engineers can be alerted to developing problems within the utility vault. Additionally, such a self-contained device can monitor the conditions within the challenging environment of a utility vault with a low risk of device failure in the event that the vault becomes flooded (e.g., monitor atmospheric conditions in the vault using the gas sensor whilst still being resistant to flood damage).

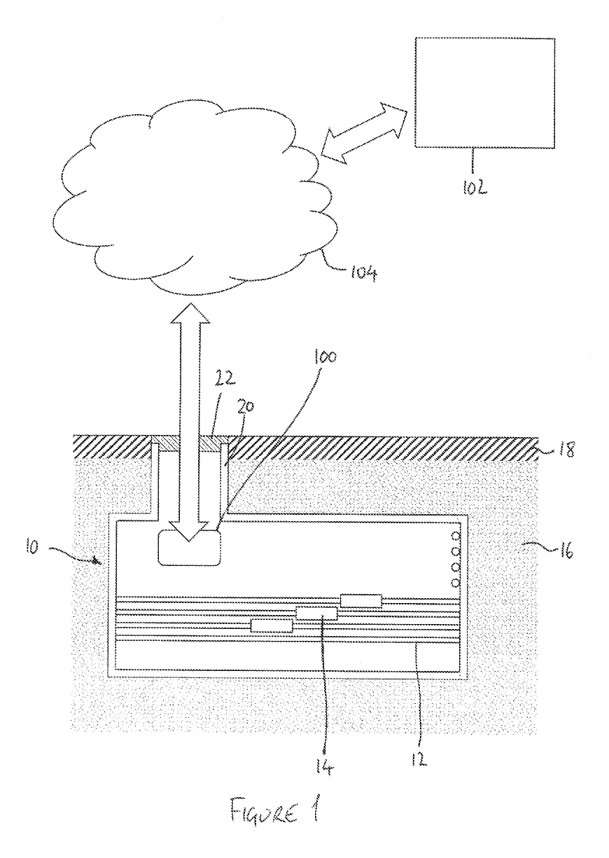

FIG. 1 shows an underground utility vault 10 that provides access to underground electrical cables 12 having connectors 14. The vault 10 is buried in the sub-surface 16 beneath a roadway 18. Access to the interior of the vault 10 is provided by an access opening 20 that is closed by a removable cover 22.

An underground utility vault monitoring system according to an embodiment of the present invention comprises a utility vault monitoring device 100 that is installed within the interior of the vault 10. The system further comprises a receiver 102 which, in this example, is a remote server located at a remote location away from the vault, for example at a central network monitoring station. Communication between the monitoring device 100 and the receiver 102 is achieved through a network 104.

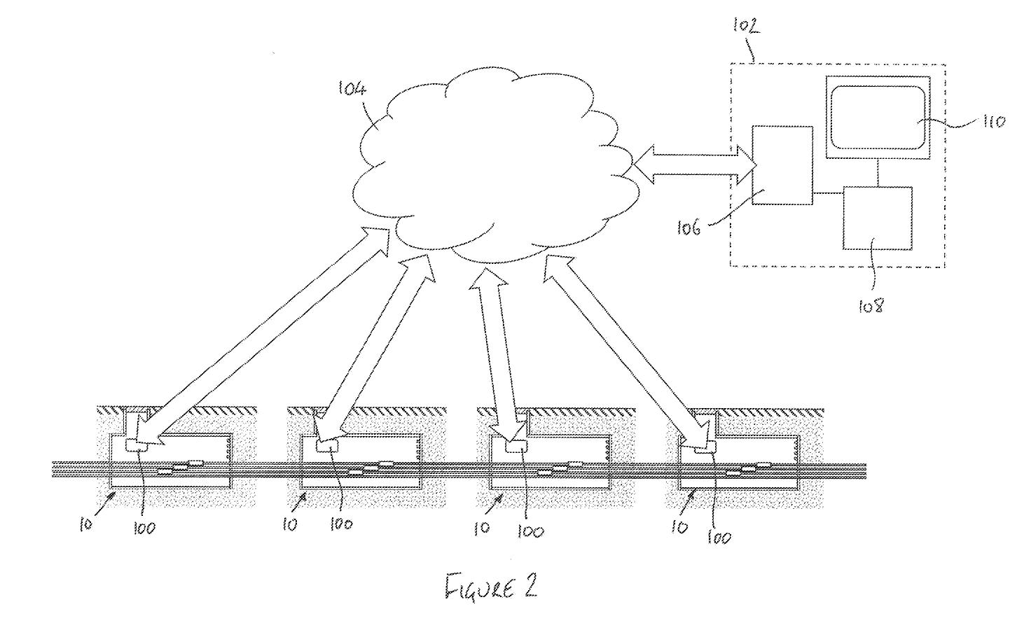

Referring to FIG. 2, in a preferred embodiment, the receiver 102 is in communication, by way of the network 104, with a plurality of monitoring devices 100 installed in a respective plurality of vaults 10. In this embodiment, the receiver 102 includes a communications module 106 for communicating with the network 104, a processor 108 for processing data received from the monitoring devices 100 to provide information about the environment in the interior of the vaults 10, and an output display device 110 to present the vault environment information to a user. The receiver 102 may include further components as are generally known in the art, and the components of the receiver 102 may be embodied as a single unit or in the form of two or more interlinked devices.

The monitoring device 100 includes a plurality of sensors for monitoring the internal environment of the vault 10. As will be explained in more detail below, a variety of sensors are included to monitor variables that are indicative of typical problems and faults that can occur in utility vaults. The sensors are selected to detect conditions such as combustion, electrical arcing, gaseous build-up, and flooding. The device 100 is configured so that, if the output of one or more sensors indicates that a fault is present, an alarm is transmitted to the receiver 102 so that appropriate action can be taken by a user of the receiver 102 or automatically. Such action may include physical inspection of the vault 10, shut-down of utilities using the vault 10, alerting local emergency services, and/or continued or enhanced remote monitoring of the vault 10.

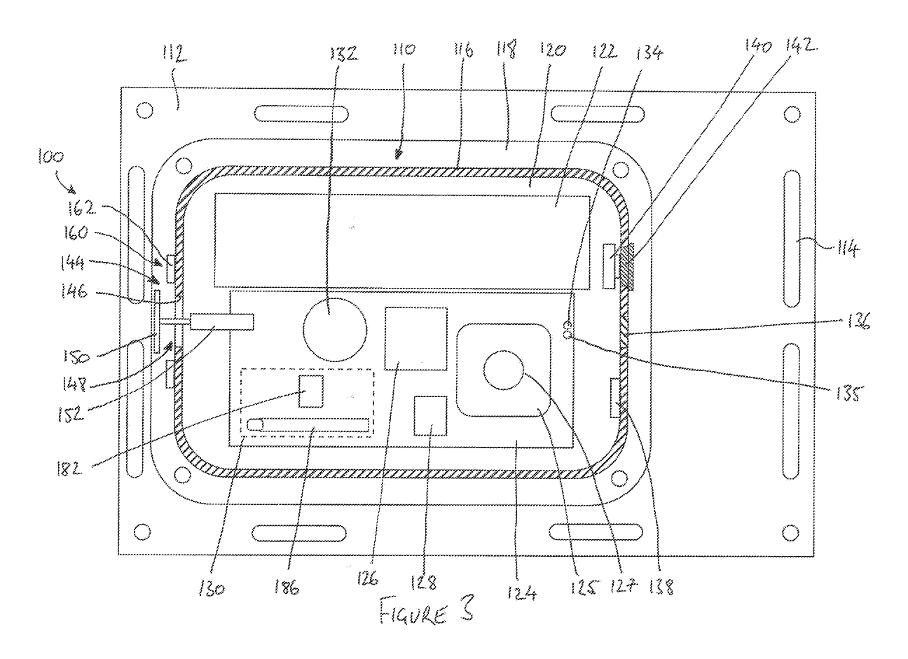

FIG. 3 shows a monitoring device 100 in more detail. The monitoring device 100 comprises a waterproof housing 110. The housing 110 is mounted to a back plate 112. The back plate 112 includes a plurality of holes and elongate slots 114 to allow the device 100 to be attached to a suitable surface in the interior of the vault 10 using appropriate fasteners. The holes and slots 114 are spaced around the periphery of the back plate 112, and more holes and slots 114 are provided than are required to secure the device 100. This provides maximum flexibility to the installer when selecting an installation site within the vault 10, since appropriate holes and slots 114 can be selected to accept fasteners and, in the case of slots, the fasteners can be positioned as necessary within the slots 114.

The housing 110 comprises a side wall 116 having a mounting flange 118 at a back end of the wall 116 for mounting the housing 110 to the back plate 112. The housing 110 may have a back face, adjacent to the back plate 112, or alternatively the housing 110 may be open on its back side and sealed against the back plate 112 to prevent water ingress between the back plate 112 and the housing 110. The front side of the housing 110 is provided with a lid (not shown) that forms a seal against the front end of the wall 116 when fitted. In this way, the housing 110 encloses an interior 120 of the device 100.

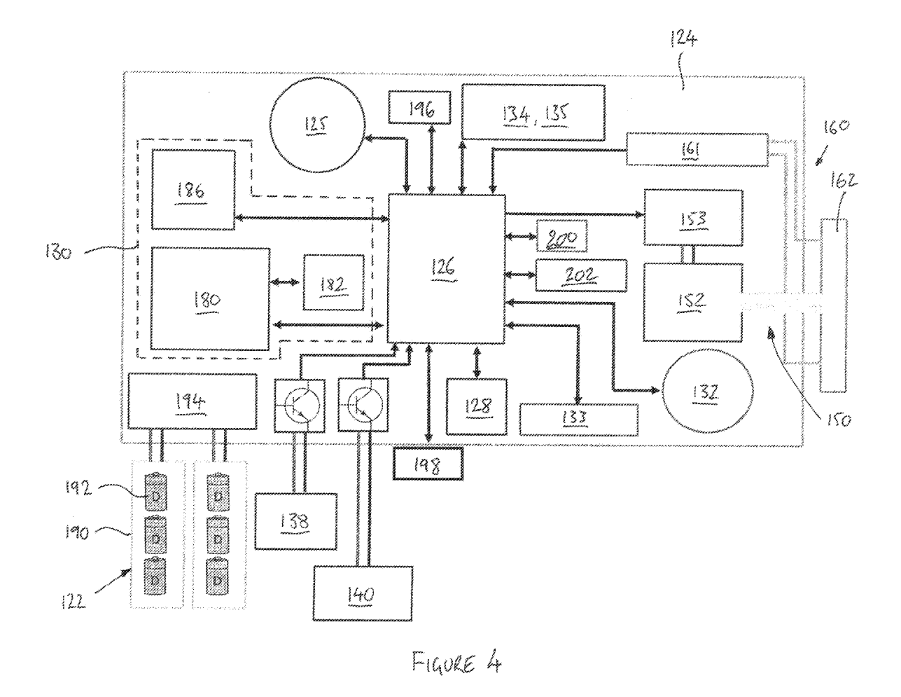

The interior 120 of the device 100 accommodates a power supply 122, a main circuit board 124 and a daughter circuit board 125 that carries a plurality of gas sensors (one of which is indicated at 127). Referring additionally to FIG. 4, which is a block diagram showing components of the device 100, the main board 124 includes a processor 126, a removable storage device slot 128 and a communications module 130.

The main board 124 also carries a smoke sensor 132, for detecting airborne particulates from combustion within the vault 10. The smoke sensor 132 is preferably a photoelectric-type smoke detector having a smoke chamber. One suitable smoke chamber is available under part no. LS-510-2 (Shenzhen Longsin Intelligence Technology Co. Ltd., Shenzhen, China). The output from the smoke chamber can for example be processed using suitable discrete circuitry or using a dedicated IC. One suitable smoke sensor IC is available under part no. RE46C190 (Microchip, Inc., AZ, USA).

The main board 124 further includes an electrical arc detector 133. The arc detector 133 comprises a high impedance antenna, formed by a length of PCB track on the main board 124. The arc detector 133 is configured to monitor the antenna for characteristic radio frequency signals arising from arcing and sparks within the vault 10. In a preferred embodiment, the arc detector 133 operates with a passband window between 50 Hz and 200 Hz with at least 40 dB of gain within the passband window.

The main board 124 is provided with indicator lights 134 for displaying the status of the device 100. A clear light pipe or window 136 (see FIG. 3) is set into the side wall 116 of the housing 110 to allow the indicator lights 134 to be seen from the exterior of the housing 110.

A photodetector 135 is mounted alongside the indicator lights 134 for the detection of light levels in the vault 10 through the window 136. In particular, the photodetector 135 can be used to detect an increased level of light in the vault 10, for example as may be caused by fire or electrical arcing. In a preferred embodiment, the photodetector 135 is a light-to-digital converter, for example as is available under part no. TSL2561T (Texas Advanced Optoelectronic Solutions, Inc., TX, USA). The indicator lights 134 are extinguished when the photodetector 135 is in use.

The main board 124 also carries an accelerometer (for example BMX055, Bosch Sensortec GmbH, Stuttgart, Germany), for detecting vibration and orientation changes of the device 100, as may be indicative of ground disturbances or tampering with the device 100.

An audio sensor (for example part no. SPW2430HR5H-B, Knowles Electronics, IL, USA) is also provided for measuring an average sound level in the vault 10, preferably in a bandwidth between approximately 100 Hz and 10 kHz, with an increase in sound level being potentially indicative of an explosive event within the vault 10.

The device 10 includes a temperature sensor, which may be integrated in the processor 126. The temperature sensor thus provides a measurement of the processor temperature and can indicate overheating of the device. An additional, separate temperature sensor (not shown) may also be provided on the main board 124.

The main board 124 and the components mounted on it are protected with a conformal coating or encapsulation, as is generally known in the art. The daughter board 125 may be unencapsulated (i.e. not wholly coated or encapsulated by a protective coating), so that sensors that would be incompatible with the coating can be mounted on the daughter board 125.

In that connection, the daughter board 125 carries a carbon monoxide sensor to measure the level of carbon monoxide within the vault 10. The presence of carbon monoxide is particularly indicative of smouldering fires and burning electrical cables. One suitable carbon monoxide sensor is available under part no. 35P-CO-1000 Package 110-109 (SPEC Sensors LLC, CA, USA). An additional carbon monoxide sensor, such as is available under part no. TGS 5042 (Figaro USA Inc., IL, USA) may also be provided.

The daughter board 125 additionally carries a methane sensor for detecting the concentration of combustible methane gas within the vault 10. Methane may leak into the vault directly from gas pipes, or may originate from nearby wastewater facilities, sewage systems and landfill sites and collect in the vault 10. A suitable methane detector is available under part no. SB-12A (FIS Inc., Itami, Japan).

The daughter board 125 also includes a humidity sensor for measuring atmospheric humidity in the vault 10. An increased humidity level may be indicative of problems such as water leakage and flooding within the vault 10. A suitable humidity sensor is available under part no. SI7021-A20 (Silicon Laboratories Inc., TX, USA).

An atmospheric pressure sensor is also provided on the daughter board 125. A change in atmospheric pressure in the vault 10 may be indicative of combustion. A suitable atmospheric pressure sensor is available under part no. BME280 (Bosch Sensortec GmbH, Stuttgart, Germany)

A tamper sensor 138 is mounted to the interior side of the side wall 116 of the housing 110. The tamper sensor 138 comprises a microswitch arranged to detect whether the lid (not shown) of the housing 110 has been removed, deformed or dislodged, indicating physical interference with the device or damage to the device due to environmental or structural conditions in the vault 10.

An activation switch 140 is also mounted to the side wall 116 of the housing 110, adjacent to an opening in the side wall 116 that is closed by a flexible rubber closure 142. The activation switch 140 comprises a push-button that can be operated from the exterior of the housing 110 by pressing a central part of the closure 142.

The interior 120 of the device 100 is in communication with the environment in the utility vault by way of a port 144. In this embodiment, the port 144 comprises a circular aperture 146 that is normally open to allow gas to exchange freely between the interior 120 of the device 100 and the utility vault 10, in particular so that the smoke sensor 132 and the gas sensors and the humidity and pressure sensor on the daughter board 125 can monitor the environment in the vault 10.

The port 144 is fitted with a valve mechanism 148 capable of closing and sealing the port 144 to prevent water ingress into the interior 120 of the device 100. The valve mechanism 148 includes a moveable valve member 150 mounted to a linear solenoid actuator 152. Preferably, the solenoid actuator 152 is of the latching type, so that power need only be supplied to the actuator 152 when switching the valve mechanism 148 between open and closed states. One example of a suitable solenoid actuator is available under part no. SK1037 (Solentec Ltd., Co. Durham, UK).

The solenoid actuator 152 is controlled, via a solenoid driver 153 (see FIG. 4), by the processor 126. As will be explained in more detail below, upon activation by the processor 126, the actuator 152 moves the valve member 150 into engagement with the periphery of the aperture 146 to seal the port 144.

The device includes a water sensor 160 having control electronics 161 mounted on the main board 124 and a water sensor detector element assembly 162 that is mounted on the outside of the side wall 116 of the housing 110 adjacent to the aperture 146 of the port 144.

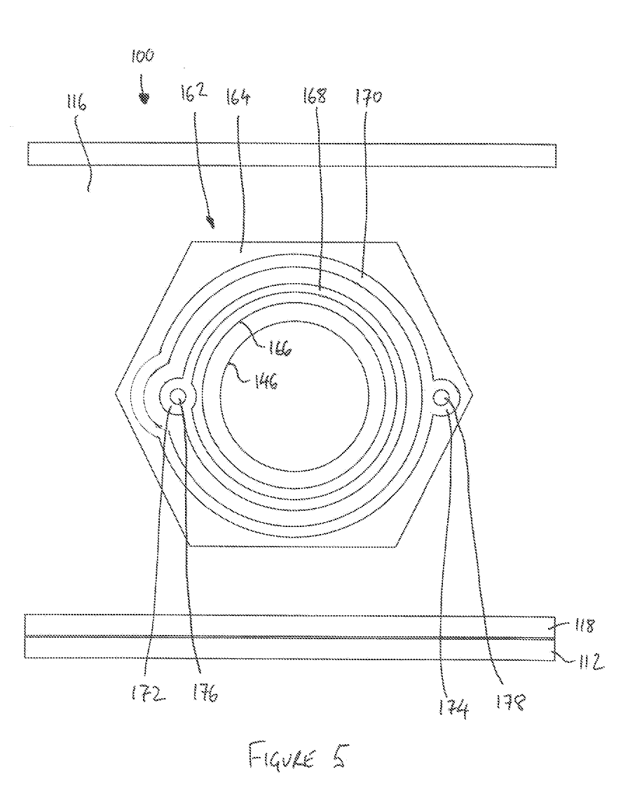

FIG. 5 shows the water sensor detector element assembly 162 in more detail. The assembly 162 comprises a base plate 164 with a central circular hole 166. The aperture 146 of the port 144 is exposed through the hole 166. A pair of annular electrical contacts 168, 170 are arranged concentrically around the hole 166. The contacts 168, 170 are separated from one another by a spacing of approximately 3 mm. Each contact 168, 170 includes a respective contact pad 172, 174 with a central drilling 176, 178. In this embodiment, the base plate 164 is a printed circuit board with ring-shaped tracks to form the annular contacts 168, 170 and the contact pads 172, 174.

Machine screws (not shown) or similar conducting fastenings are inserted through the drillings 176, 178 and through corresponding holes in the side wall 116 of the housing 110 to provide connections to the contacts 168, 170 in the interior 120 of the housing 110. O-rings or other suitable seals (not shown) are used to ensure that water cannot reach the interior 120 through the holes.

The control electronics 161 are configured to monitor the electrical conductivity between the contacts 168, 170. An increase in conductivity signifies that water has formed a bridge between the contacts 168, 170, which is indicative of the housing 110 being in contact with water (for example due to flooding of the utility vault 10). In one example, the control electronics 161 include a low-current op-amp oscillator for applying an ac signal to one of the contacts 168, a receiver circuit for detecting the signal amplitude received at the other contact 170, and a comparator for determining if the signal amplitude exceeds a threshold value. Because of the annular configuration of the contacts 168, 170, the water sensor 160 can detect rising flood water before the water reaches the aperture 146 of the port 144, irrespective of the orientation of the device 100 within the vault 10.

Referring again to FIG. 4, the communications module 130 comprises, in this embodiment, a cellular modem 180 and a connected SIM card slot 182 to facilitate data communication with the receiver 102 by way of a cellular network. Preferably, the modem supports SMS messaging and data transfer via GSM or other suitable services. Examples of suitable modems are available under part nos. SIM900 and SIM5320 (SIMCom Wireless Solutions Ltd., Shanghai, China), but it will be appreciated that alternative modem devices could be selected for compatibility with regional network requirements and availability.

In this example, the communications module 130 also includes an ISM (industrial, scientific, medical)-band radio 184 to facilitate data communication with the receiver 102 by way of a local wireless network, such as a wireless mesh network, or with a local device (such as a handheld receiver).

The communications module 130 is provided with suitable aerials for the GSM modem 180 and the ISM-band radio 184, one of which is shown at reference 188 in FIG. 3.

Referring back to FIG. 4, in this embodiment the power supply 122 comprises two battery packs 190, each having three 3.6 V lithium “D”-size cells 192. Each battery pack 190 is connected to the main board 124 by battery management electronics 194. In other embodiments, alternative configurations of one or more battery packs, each including one or more cells of any suitable voltage, capacity and size, may be selected according to the power requirements of the device. For example, in another embodiment, four battery packs, each having six 3.6 V lithium cells, are provided.

The device 100 also includes a USB interface 196 and an RS485 serial port 198. These serial interfaces allow direct communication between the device 100 and a PC or other portable device during installation and servicing. A real-time clock (RTC) 200 and EEPROM memory module 202 are also provided.

It will be appreciated that various other components not explicitly mentioned above may be housed in the interior of the devices, but for clarity these components have been omitted from FIGS. 3 and 4. Similarly, additional electrical and mechanical connections that are not shown in FIGS. 3 and 4 may be provided.

The processor 126 is programmed to execute a set of software commands that cause the device 100 to obtain information about the internal environment of the vault 10, collate that information in the form of logs and data packets, and communicate that information to the receiver 102. The processor 126 is preferably a low-power, ARM-based microcontroller, such as is available under part no. SAM D 21 (Atmel Corporation, CA, USA), although any suitable processor could be used. Preferably, the processor 126 includes embedded flash and RAM memories.

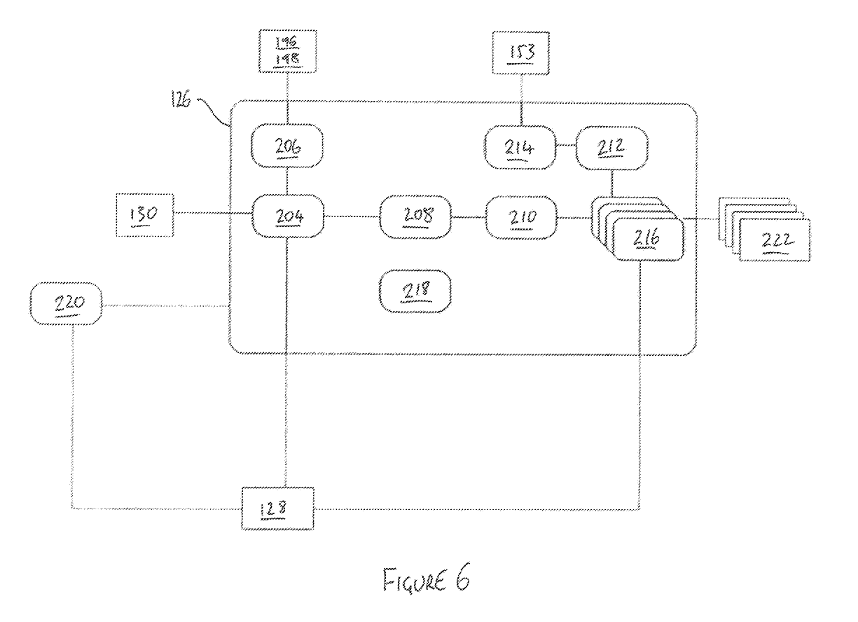

FIG. 6 shows the software architecture of the device 100. The processor 126 runs firmware that provides a command interface 204, an access control module 206, a reporting module 208, a polling module 210, an alarm module 212, a flood protection module 214 for controlling the solenoid driver 153, a plurality of sensor modules 216, and a power management module 218.

The removable storage slot 128 is preferably a Secure Digital (SD) card slot. The SD card slot 128 communicates with the command interface 204 and the sensor modules 216, and with an external boot loader 220. An SD card inserted in the slot 128 can store firmware image files for firmware update, log files showing, for example, serial port traffic, modem traffic and error reports, and configuration data. The SD card slot may be of any suitable form factor (e.g. standard, mini SD or micro SD). Different removable storage media formats may be used instead of SD.

The boot loader 220 is a stand-alone software module that can run the main firmware image already stored in memory or replace it with a new firmware image stored on the SD card. The new image may be provided by physical replacement of the SD card, by download through one of the serial interfaces 196, 198, or by download through the communication module 130. Operation of the boot loader 220 may be triggered remotely or by the activation button 140.

The command interface 204 communicates with the communications module 130. The command interface 204 also connects, via the access control module 206, with the serial interfaces 196, 198. The command interface 204 is configured to take command inputs from the communications module 130 or the serial interfaces 196, 198, parse and action those commands, and route the response back to the originating interface. The access control module 206 prevents unauthorised access to the command interface 204 by password control. Communications between the device 100 and the receiver 102 are preferably by HTTPS, with a level of encryption to guard against interception.

Each of the sensor modules 216 interfaces with a corresponding hardware sensor. The sensors, which are identified generically in FIG. 6 with reference 222, are as already described above. The sensors 222 thus include the water sensor 160, the smoke sensor 132, the photodetector 135, the arc detector 133, the accelerometer, the temperature sensor, the audio sensor, the carbon monoxide sensor, the methane sensor, the humidity sensor and the atmospheric pressure sensor. The sensors 222 also include the tamper sensor 138 and the activation switch 140.

To minimise power consumption within the device 100, and so maximise the life of the power source 122, the device 100 actively manages the distribution of power to the components of the device 100. To this end, the power management module 218 controls power to a plurality of power domains that can be powered down when not required. In this embodiment, the carbon monoxide sensor, the methane sensor, the smoke sensor 132 and the arc sensor 133 are all in separate power domains that can be powered up or down independently. The remainder of the daughter board 125, including the humidity and atmospheric pressure sensors, share a further power domain. The communications module 130 and the solenoid valve 150 are in further separate power domains.

In each of these cases, the power management module 218 switches the corresponding power domain on when the component or module is to be active, and then switches the power domain off when the component or module is not required. Certain sensors, such as the methane sensor and the carbon monoxide sensor, must be powered-up for some time in advance of a measurement being taken to provide accurate readings. Components that consume little power, such as the water sensor 160, can be permanently supplied.

In this way, the device 100 is configured so that, by switching of the power domains, one or more of the sensors 222 are switchable between a sleep state in which the sensor 222 is not operational and an awake state in which the sensor 222 transmits output data to the processor 126, by way of the corresponding sensor module 216.

The processor 126 is also switchable between a low-power “sleep” state and a “running” state in which the processor 126 has full functionality. The processor 126 normally remains in the “sleep” state until woken by an interrupt. The interrupts can be generated at regular intervals by the clock 200, and by a sub-set of the sensors 222.

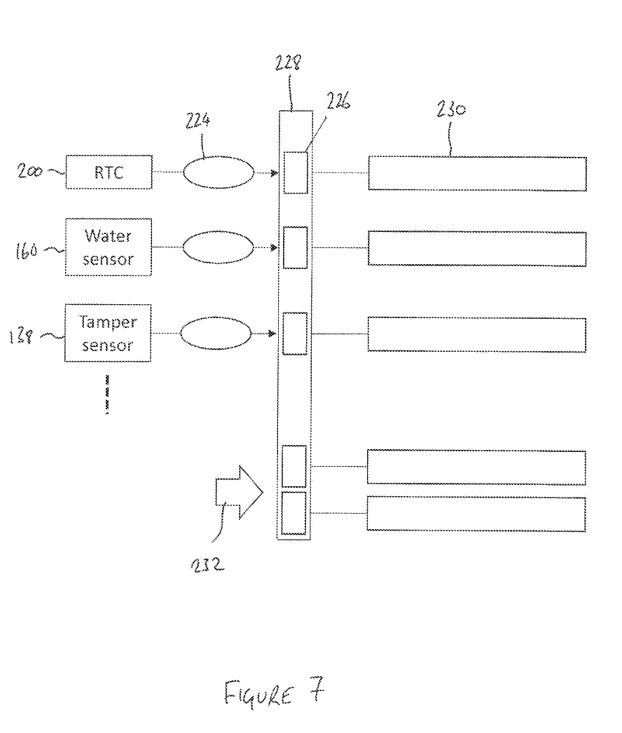

The interrupts provide inputs to a wake bus data structure, which is shown schematically in FIG. 7. In this example, the components that can generate interrupts include the clock 200, the water sensor 160 and the tamper sensor 138, but further sensors may also be able to generate interrupts. Power to the interrupt-generating sensors is always supplied. When an interrupt is generated, for example by a pre-determined period of time elapsing in the case of the clock 200, or by an activation event in the case of one of the sensors 160, 138, an interrupt service routine 224 sets a flag bit 226 in the wake bus 228. Each flag bit 226 is associated with a corresponding power supply mask 230, which indicates which of the power domains should be enabled to allow the system to perform the associated processes.

Non-interrupt code, indicated at 232, may also set flag bits 226 in the wake bus 228. This code 232 does not cause the processor 126 to wake, but instead causes the processor 126 to perform functions when it next wakes due to an interrupt. For example, the polling module 210 and the reporting module 208 set corresponding flag bits 226 when pre-determined polling and reporting time intervals have elapsed.

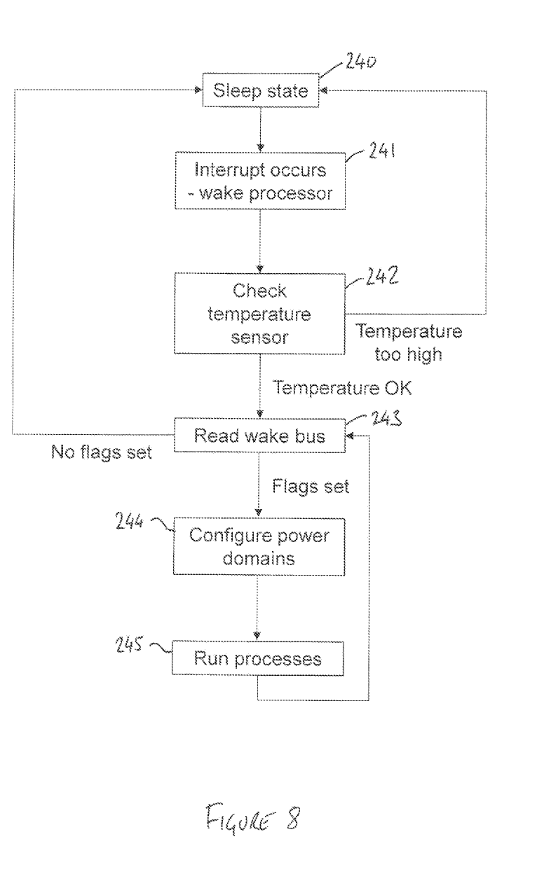

FIG. 8 is a flowchart showing the behaviour of the system, starting with the processor 126 in a sleep state (step 240). When an interrupt occurs, the processor 126 switches into a running state (step 241). To protect the processor 126 and other device components from overheating, the temperature sensor is checked immediately (step 242). If the temperature exceeds a predetermined threshold, the processor 126 returns to the sleep state. Otherwise, the processor 126 reads the wake bus (step 243).

If one or more flag bits 226 are set in the wake bus 228, all of the power domains indicated by the respective power supply mask 230 for each set flag bit 226 are switched on (step 244).

At step 245, processes are run depending on which flag bits 226 are set in the wake bus 228. The processes may include polling one or more sensors, logging sensor output data to the SD card or other memory, compiling and transmitting a reporting data packet using the communications module 130, compiling and transmitting an alarm data packet using the communications module 130, opening or closing the port 144 using the valve 150, and so on, as will be explained in more detail below.

After each process has been completed, the corresponding flag bit 226 can be set to zero and the corresponding power domain can be shut off. The wake bus is read again (step 243) and the cycle continues until all of the flag bits 226 are set to zero. At that point, the processor 126 returns to the sleep state (step 240).

The clock 200 is configured to issue a periodic interrupt to wake the processor 126 at regular intervals (for example once per second), so that the wake bus 228 is checked regularly for flag bits 226 that have been set by processes 232 that do not themselves issue interrupts.

For instance, the polling module 210 sets a flag bit 226 in the wake bus 228 when a configurable polling time interval has elapsed, without an interrupt. The polling time interval can be set during commissioning of the device 100 and adjusted using the command interface 204 as necessary. The polling time interval may be set, for example, at 60 minutes, although longer or shorter durations may be appropriate depending on the circumstances. When the polling module flag bit 226 is read (step 243 of FIG. 8), the processor 126 powers up the power domains associated with the sensors 222, takes readings from all of the sensors 222 and records the results in a log file, for example on the SD card, and then sets the polling module flag bit 226 to zero.

Similarly, the reporting module 208 sets a flag bit 226 in the wake bus 228 when a configurable reporting time interval has elapsed, without an interrupt. The reporting time interval can also be set during commissioning of the device 100 and adjusted using the command interface 204 as necessary.

When the reporting module flag bit 226 is read, the processor 126 powers up the power domain associated with the communications module 130, compiles a reporting data packet, and attempts to transmit the reporting data packet to the receiver 102 using the communications module 130. If the transmission is successful, the reporting module flag bit 226 is set to zero.

The reporting time interval may be set, for example, at 12 hours, although longer or shorter durations may be appropriate depending on the circumstances. Preferably, the reporting time interval is an integer multiple of the polling interval, so that reporting can always be performed when the processor 126 is already running for polling. To distribute load on the network and the receiver 102, the reporting time interval can be configured to include a random time component, so that the actual transmission times are distributed within a reporting time interval window.

The reporting data packet includes the logged results from all of the polling events that have taken place since the last reporting event. Each result is accompanied by the date and time values corresponding to the time that the corresponding sensor measurement was taken.

The device 100 can also send an ad-hoc reporting data packet upon request from the receiver 102. For example, upon receipt of a request, the command interface 204 can set a suitable flag bit 226 in the wake bus 228 that causes the processor 126 to compile and transmit a reporting data packet as soon as possible.

Under certain conditions, the device 100 enters an alarm state, in which the alarm module 212 causes a report to be sent to the receiver 102 as soon as possible. This occurs when one or more of the sensors 222 returns a result that can be indicative of a developing fault within a vault 10. The alarm state is triggered only by certain sensors 222, designated primary sensors. The remaining sensors 222 are designated secondary sensors. Each of the primary sensors may either be permanently powered up, or attached to a power domain that is normally powered down and polled at the normal polling time interval as determined by the polling module 210 so as to switch the corresponding primary sensor from a sleep state to an awake state.

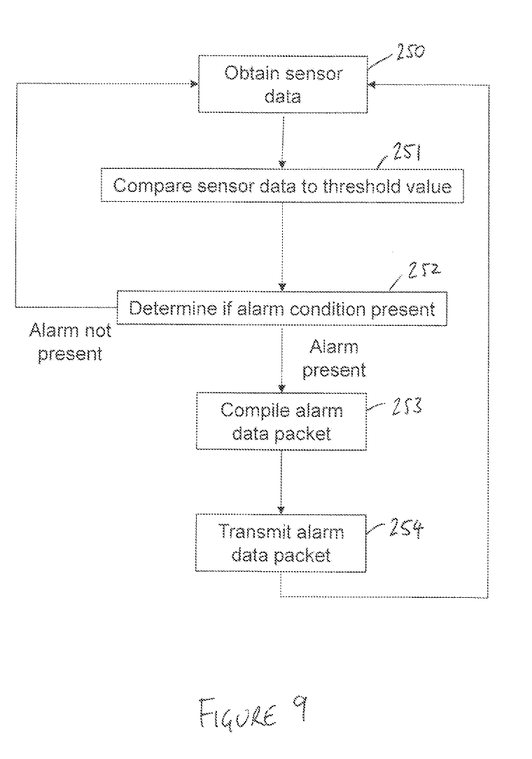

FIG. 9 shows a sequence of events in which an alarm may be triggered by a primary sensor. After obtaining the sensor data (step 250), the data is tested against one or more threshold values (step 251). It is then determined whether an alarm condition is present (step 252). If the sensor data falls within the threshold values, no further action is taken and the process resumes from the start (with monitoring of the sensor either continually or as determined by the polling time interval).

If the sensor data falls outside the threshold values, the alarm module 212 moves into an alarm state. The alarm module 212 triggers an interrupt to fully wake the processor 126 (if it is not already awake), and causes the processor 126 to compile an alarm data packet (step 253) and to transmit the alarm data packet to the receiver 102 (step 254) via the communications module 130.

The alarm module 212 remains in the alarm state until a reset command is sent from the receiver 102 to the device 100. This clears the current alarm state, but the alarm state may recur again immediately when the primary sensor is re-read on the next cycle.

The alarm data packet includes data from the primary sensor that triggered the alarm, along with data from at least one secondary sensor. This provides additional information to the receiver 102 that can be used to identify the precise nature of a fault when an alarm occurs. Preferably, when an alarm occurs, all of the sensors 222 (i.e. the primary and the secondary sensor) are polled and data from all of the sensors 222 is included in the alarm data packet. Such polling can be achieve by the setting of suitable flag bits 226 in the wake bus 228, as previously described.

In most cases, the sensor data will be compared to a maximum threshold value, with an alarm state being identified when the sensor output exceeds the threshold value. In some cases, however, it may be desirable to compare the sensor data to a minimum value, or to maximum and minimum limits. For some primary sensors, the step of comparing sensor data to one or more threshold values is not necessary. For example, the tamper sensor 138 produces a binary true or false result, which allows direct determination of whether an alarm state is present when the tamper sensor 138 is used as a primary sensor.

It has been determined that using the carbon monoxide sensor as a primary sensor can be particularly effective. This is because the presence of carbon monoxide in a vault provides an early indication of combustion, particularly smouldering combustion which can be caused by shorting and arcing of cables. In some embodiments, an alarm state is identified when the carbon monoxide level exceeds a threshold value of between approximately 20 ppm (parts per million) and approximately 50 ppm. In some embodiments, the threshold value is between approximately 30 ppm and approximately 40 ppm. In preferred embodiments, the threshold value is approximately 35 ppm.

The water sensor 160 may also be used as a primary sensor. In this case, when the conductivity between the contacts 168, 170 of the water sensor 160 exceeds a threshold value, an alarm condition is set in accordance with the sequence in FIG. 9. The flood protection module 214 is also triggered to set a corresponding flag bit 226 in the wake bus 228 and an interrupt is issued to wake the processor 126 (if it is not already in the running state). Upon reading the wake bus 228, the power domain associated with the valve 150 is enabled. The processor 126 then causes the solenoid driver 153 to close the valve 150, preventing water ingress into the interior 120 of the device 100. Power to the valve 150 is then shut down and the valve 150 remains latched closed. When the water sensor 160 detects that the water has receded, another flag bit 226 in the wake bus 228 is set and another interrupt is issued. The valve 150 can then be powered up and opened so that the device 100 can resume monitoring of the atmosphere in the vault 10. Opening of the valve 150 may be triggered automatically by the flood protection module 214 as soon as the water has receded, or alternatively the device could be configured to wait until a reset command has been issued by the receiver 102 before opening the valve.

A single sensor 222 may act as the primary sensor, in which case the primary sensor is preferably the carbon monoxide sensor. In other cases, a plurality of sensors may be primary sensors. For example, one or more of the temperature sensor, arc sensor, water sensor, tamper sensor and smoke sensor could be selected as primary sensors. In a preferred example, the device 100 includes a first primary sensor comprising a carbon monoxide sensor and a second primary sensor comprising a temperature sensor. The device 100 may allow each sensor 222 to be reconfigured as a primary sensor or a secondary sensor through software. The device 100 may also allow all alerts to be suppressed, for example when maintenance on the device 100 or the vault 10 is underway.

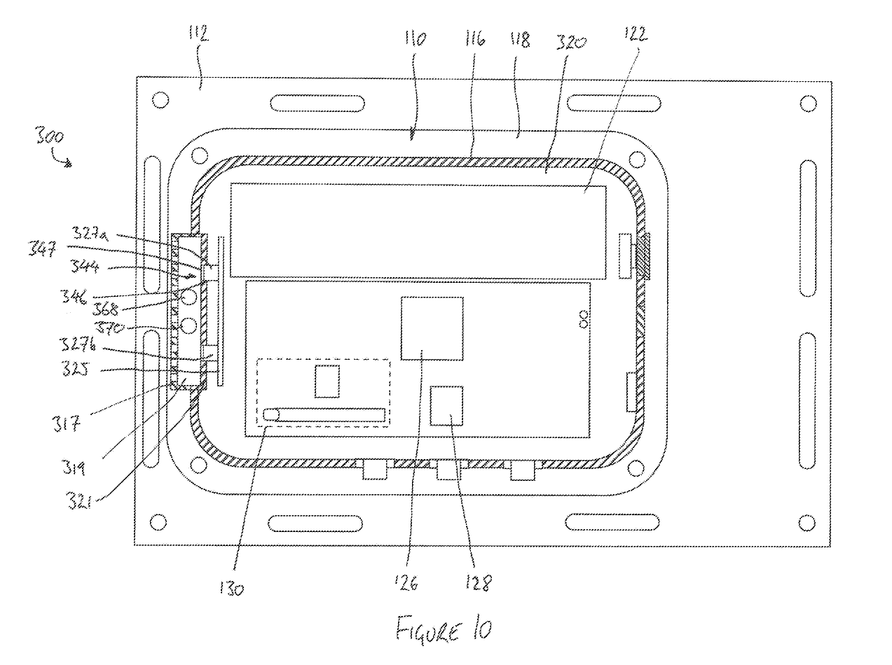

FIG. 10 shows another embodiment of the device 300, which is similar to the device 100 of FIG. 3 in many respects. Like reference numerals are used for like parts, and only the differences will be described in detail.

In the device 300 of FIG. 10, the daughter board 325 is mounted adjacent to the side wall 116 of the housing 110. A pair of gas sensors are carried on the daughter board 325. In the illustrated example the sensors comprise a carbon monoxide sensor 327a and a methane sensor 327b, but in another possible arrangement both sensors are carbon monoxide sensors. Each sensor 327a, 327b is aligned with a corresponding port 344. Each port 344 comprises an aperture 346 in the housing wall 116.

To prevent water ingress, each of the apertures 346 is covered by a micropermeable membrane 347, preferably a stretched polytetrafluoroethylene (PTFE) material such as Gore-Tex (registered trade mark). The membranes 347 allow gas and water vapour to pass through the ports 344 to reach the sensors 327a, 327b, but substantially prevent the passage of water through the ports 344, even if immersed in water. Accordingly, the device 300 does not require a valve to close the ports 344, as the interior 120 of the device 300 remains both air and water tight at all times.

To protect the membranes 347, the housing 110 is provided with a grille cover 317 that encloses a small sensing chamber 319 external to the interior 120 of the device 300 and set into a recessed part 321 of the housing wall 116. The sensing chamber 319 is therefore defined in part by the exterior of the housing 110. In the illustrated example, the grille cover 317 projects beyond the housing wall 116, but in another possible arrangement, the grille cover 317 lies flush with the remainder of the exterior of the housing 110.

The grille cover 317 is preferably of a plastic material and may be of the same material as the housing wall 116, although a different material could instead be used. Conceivably, the cover 317 could be an integral part of the housing 110. A plurality of slots or apertures in the grille cover 317 allow substantially unrestricted communication of gaseous and liquid fluid between the utility vault environment and the sensing chamber 319. In this way, the environment within the sensing chamber 319 is substantially the same as the environment in the utility vault outside the sensing chamber 319. Instead of a grille, the cover 317 could comprise a mesh, a perforated screen or similar arrangement.

In this embodiment, the water sensor detector contacts comprise two studs 368, 370 that extend through the wall of the housing 110 into the sensing chamber 319 to allow the water sensor to determine whether water is present in the sensing chamber 319.

By disposing the studs 368, 370 in the sensing chamber 319, the output from the water sensor is indicative of flood conditions immediately adjacent to the ports 344, allowing the output from the gas sensors 327a, 327b to be interpreted with knowledge of the flood conditions. For example, the gas sensors 327a, 327b are likely to output a zero value for gas concentration both when the gas concentration is genuinely zero and also when the sensing chamber 319 is flooded. A contemporaneous detection of flood conditions from the water sensor allows differentiation between these possibilities.

It will be appreciated that, in the embodiment of FIG. 10, a water sensor detector element of the type shown in FIG. 5 may be used in place of the studs 368, 370. Similarly, a valve mechanism of the type shown in FIG. 3 may be used in place of the micropermeable membrane 347.

Although not shown in FIG. 10, the device 300 may include a humidity sensor and/or an atmospheric temperature sensor. Such sensors can be mounted on the daughter board 325 and provided with corresponding ports 344 of the type described above to allow gas exchange between the sensing chamber and the sensors. The device 300 illustrated in FIG. 10 does not include a smoke sensor.

The device 300 of FIG. 10 also includes a plurality of waterproof connectors 399 mounted on the side wall 116 of the housing 110. The connectors 399 allow electrical connections to be made to various optional external peripheral devices.

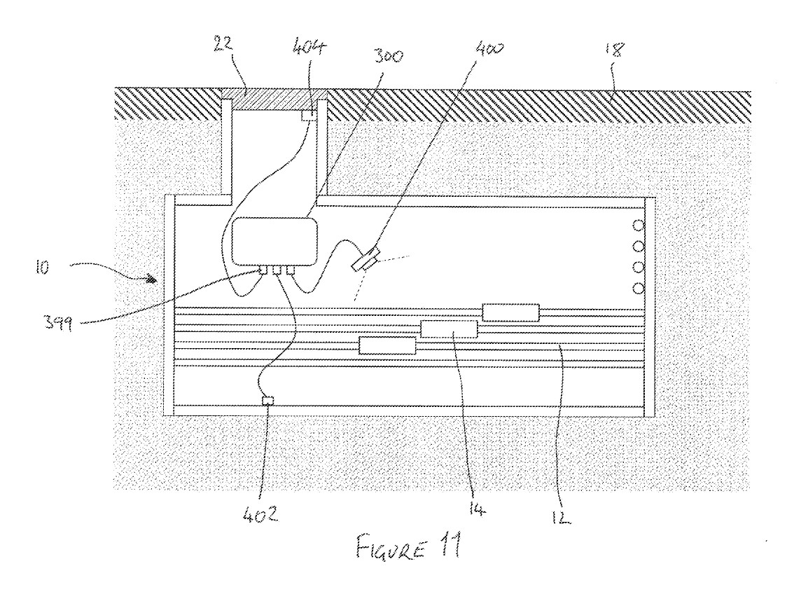

FIG. 11 illustrates the device 300 installed in a utility vault 10, with three external peripheral devices connected to the device 300 by way of the connectors 399.

One peripheral device comprises a camera module 400. In this example, the camera module 400 includes a visible light camera and an infrared camera. The camera module 400 is mounted in the vault 10 so that the cameras are aimed towards an area of interest in the interior of the vault 10 (in this case the cables 12 and connectors 14).

In this case, the device 300 is configured so that, when an alarm condition has been triggered, an instruction is sent to the camera module 400 to acquire one or more images of the interior of the vault 10. For example, operation of the camera module 400 can be controlled by processes triggered when suitable flag bits 226 are set in the wake bus 228. The or each image can be transmitted to the receiver 102 in one or more image data packets, preferably following the alarm data packet, or alternatively the images could be included in the alarm data packet. In either case, the images are made available on the receiver 102 to aid diagnosis of faults by inspection of the images by a user at the receiver end. Infrared images obtained in this way can be particularly useful in identifying or confirming hot areas due to combustion or arcing. Visible light images can be useful for identifying or confirming flooding and/or physical intrusion in the vault 10. Camera images could also be obtained upon request from the receiver 102.

The camera module 400 may have any suitable form. It is conceivable that the camera module could be equipped with a single camera, in which case the camera could be an infrared or visible light camera. It is also possible that a single camera able to acquire both infrared and visible light images could be provided.

Further peripheral devices comprise a salinity sensor 402 and a ground temperature sensor 404.

The salinity sensor 402 obtains an indication of the level of salinity in runoff water by measuring the electrical conductivity of water. In this example, the salinity sensor 402 is mounted at the base of the vault 10 to measure the salinity of water runoff. The ground temperature sensor 404 is mounted high in the vault 10, adjacent to the cover 22 in this example, to provide an indication of the temperature of the roadway 18. High salinity levels and/or extreme ground temperatures can accelerate degradation of cables and can contribute to the generation of stray voltages. Salinity and ground temperature measurements may also be useful for the planning of road salting.

Both the salinity sensor 402 and the ground temperature sensor 404 are preferably configured as secondary sensors, although it is conceivable that either sensor could be used as a primary sensor in some applications.

Although not shown in FIG. 11, further peripheral devices could be connected to the device 300 by way of further connectors 399. For example, a stray voltage sensor may be provided to monitor the voltage on the cover 22 or on other exposed parts of the vault 10. The stray voltage sensor, when provided, may be configured as a primary sensor instead of or in addition to other primary sensors. Where the vault 10 includes cathodic protection to protect metal components from corrosion, a peripheral device comprising a low-voltage cathodic DC voltage detector may be provided to monitor the corrosion of the metal parts, for example, by monitoring the condition of a sacrificial anode.

Further peripheral devices, not shown in FIG. 11, could also include antennas for the communications module 130, and/or for an electrical arc sensor.

Any suitable communication system and protocol could be used to allow two-way communication between the devices 100, 300 and the receiver 102. Possible considerations in the selection of the communications system include the limited available battery power in the devices 100, 300, coupled with the relatively high power required to reliably transmit and receive signals from the interior of an underground vault 10.

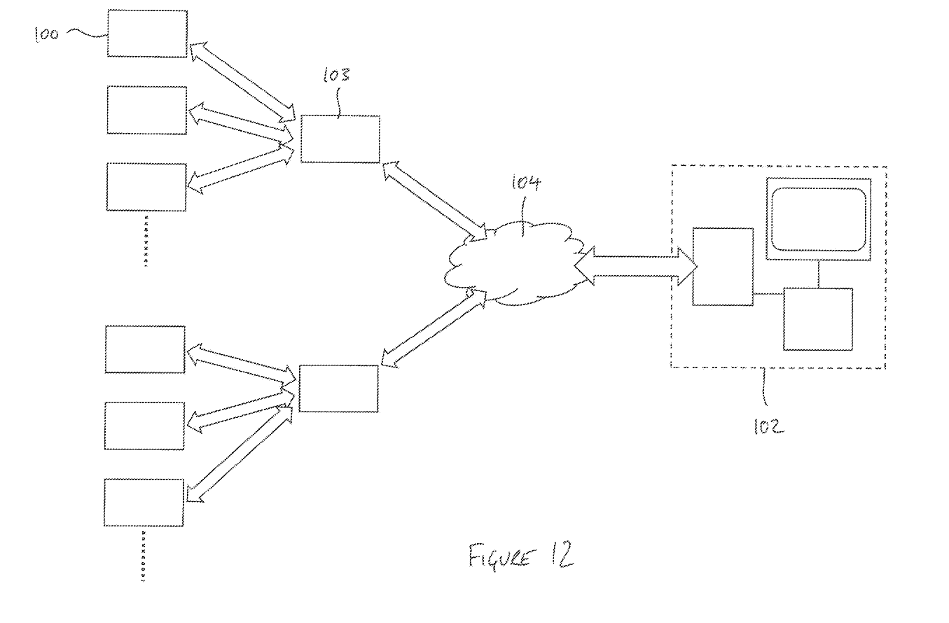

To that end, a plurality of data concentrators may be provided in the communications path between the devices and the receiver, as illustrated in FIG. 12.

In this case, each device 100 communicates with a local data concentrator 103. Each data concentrator 103 serves a plurality of devices 100, with two data concentrators 103 being illustrated in FIG. 12. Communication between the devices 100 and the data concentrator 103 could be, for example, by GSM, ISM radio, NarrowBand IoT, by power line communication, or by any other suitable communications protocol. The data concentrators 103, in turn, relay communications to and from the receiver 102 via the network 104. Communication between the data concentrators 103 and the network 104 may be by higher bandwidth protocols, such as LTE (4G).

Most preferably, the reporting and alarm data packets described above are network packets for transmission by a packet-switched network as is generally known in the art. However, the term “data packet” should be construed broadly, and could for example comprise a collection of data assembled for subsequent transmission as a continuous bit stream.

In the illustrated embodiments, the devices are powered by internal batteries. In alternative embodiments, power could be obtained from a source external to the device. In these cases, internal batteries may be omitted or provided as a backup, preferably in rechargeable form.

For example, power could be harvested parasitically from a power cable within the vault using a suitable inductive device. The inductive device could also, or alternatively, serve as a current sensor to monitor the current flowing in the power cable. Preferably, the current sensor forms a secondary sensor of the device.

In another example, power is drawn from a suitable mains or grid power supply within the vault. For instance, the device could be provided with a three-phase power input, which may for example be tapped from a power cable within the vault. When the device is connected to a mains or grid power supply, the device may include a voltage sensor to monitor the mains voltage. Preferably, the voltage sensor forms a secondary sensor of the device.

In the illustrated embodiments, the device transmits data to a receiver in the form of a remote server. However, the device may transmit data to a receiver of a different form. Examples of receivers include, but are not limited to, a computing device such as a server, one or more computers, portable computers, tablet computers, cellular phones, wearable devices (e.g. watches, glasses, lenses, clothing and/or the like), personal digital assistants (PDAs), a processor, a storage device, and/or similar computer components. The receiver may be capable also of transmitting data to the device as well as receiving data from the device.

The devices and/or components described herein can perform one or more processes described herein. For example, the devices and/or components can perform at least a portion of such processes based on a processor executing software instructions stored by a computer-readable medium, such as memory and/or storage component. A computer-readable medium (e.g., a non-transitory computer-readable medium) is defined herein as a non-transitory memory device. A memory device includes memory space located inside of a single physical storage device or memory space spread across multiple physical storage devices.

When executed, software instructions stored in a computer-readable medium may cause a processor to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A device for monitoring an underground utility vault environment, including:
a plurality of environmental sensors comprising at least one primary sensor and at least one secondary sensor;
a processor configured to receive output data from the sensors and to compile an alarm data packet; and
a communications module configured to transmit data from the device;
wherein the processor is configured to:
determine whether an alarm condition is present based on the output data from the or each primary sensor;
and, when it is determined that an alarm condition is present, compile the alarm data packet comprising data derived from the or each primary sensor and the or each secondary sensor, and cause the communications module to transmit the alarm data packet;
and wherein the plurality of environmental sensors includes a primary sensor comprising a carbon monoxide sensor.

2. A device according to claim 1, including a further primary sensor comprising a temperature sensor.

3. A device according to claim 1, comprising one or more further primary sensors selected from the group consisting of an electrical arc sensor, a smoke sensor, a stray voltage sensor, a water sensor, and a tamper sensor.

4. A device according to claim 1, comprising one or more secondary sensors selected from the group consisting of a humidity sensor, an atmospheric pressure sensor, a methane sensor, a water sensor, an acceleration sensor, a tamper sensor, a light sensor, a current sensor, a voltage sensor and an audio sensor.

5. A device according to claim 1, further comprising a camera module, wherein the processor is configured to cause the camera module to acquire an image of the interior of the utility vault when it is determined that an alarm condition is present, and to transmit the acquired image.

6. A device according to claim 5, wherein the camera module is configured to acquire an infrared image.

7. A device according to claim 5, wherein the camera module is configured to acquire a visible light image.

8. A device according to claim 1, wherein the or at least one of the secondary sensors is switchable between a sleep state in which the sensor is not operational and an awake state in which the sensor transmits output data to the processor, and wherein the processor is configured to switch the sensor from the sleep state to the awake state when it is determined that an alarm condition is present.

9. A device according to claim 1, wherein the or at least one of the primary sensors is switchable between a sleep state in which the sensor is not operational and an awake state in which the sensor transmits output data to the processor, and wherein the processor is configured to switch the sensor from the sleep state to the awake state at predetermined polling time intervals.

10. A device according to claim 1, wherein the processor is configured to obtain data from at least one sensor at predetermined polling time intervals and to log the obtained data in a memory.

11. A device according to claim 10, wherein the processor is configured to compile one or more reporting data packets comprising logged data and to cause the communications module to transmit the one or more reporting data packets at predetermined reporting time intervals.

12. A device according to claim 10, wherein the processor is configured to cause the communications module to transmit one or more reporting data packets upon receiving a request.

13. A device according to claim 1, wherein the communications module is configured to receive firmware update data from a remote server.

14. An underground vault monitoring system, comprising a device according to claim 1 and a receiver configured to communicate with the device by way of a network.

15. An underground vault monitoring system, comprising a plurality of devices according to claim 1 and a receiver configured to communicate with each of the devices by way of a network.

16. A method for monitoring an underground utility vault environment, including:
determining, with at least one processor, whether an alarm condition is present based on output data from at least one primary sensor of a plurality of environmental sensors, the plurality of environmental sensors comprising the at least one primary sensor and at least one secondary sensor, and wherein the plurality of environmental sensors includes a primary sensor comprising a carbon monoxide sensor;
when it is determined that an alarm condition is present, compiling, with at least one processor, an alarm data packet comprising data derived from the or each primary sensor and the or each secondary sensor; and
causing, with at least one processor, a communications module to transmit the alarm data packet.

17. The method of claim 16, further comprising:
causing, with at least one processor, a camera module to acquire an image of the interior of the utility vault when it is determined that an alarm condition is present, and to transmit the acquired image.

18. The method of claim 16, wherein the or at least one of the secondary sensors is switchable between a sleep state in which the sensor is not operational and an awake state in which the sensor transmits output data, the method further comprising:
switching, with at least one processor, the sensor from the sleep state to the awake state when it is determined that an alarm condition is present.

19. The method of claim 16, the or at least one of the primary sensors is switchable between a sleep state in which the sensor is not operational and an awake state in which the sensor transmits output data to the processor, the method further comprising:
switching, with at least one processor, the sensor from the sleep state to the awake state at predetermined polling time intervals.

20. The method of claim 16, further comprising:
obtaining, with at least one processor, data from at least one sensor at predetermined polling time intervals;
logging, with at least one processor, the obtained data in a memory;
compiling, with at least one processor, one or more reporting data packets comprising logged data; and
causing, with at least one processor, the communications module to transmit the one or more reporting data packets.
